(19) United States
(12) Patent Application Publication
(10) Pub. No.: US 2004/0159648 A1
(43) Pub. Date: Aug. 19, 2004

(54) Bagel oven baking apparatus

(76) Inventor: John Trojian, Brick, NJ (US)

Correspondence Address: JOHN TROJIAN, 584 KAREN LANE, BRICK, NJ, 08724, US

(21) Appl. No.: 10/335,527

(22) Filed: Jan. 3, 2003

(51) Int. Cl. A21B 1/00; A21B 1/22

(52) U.S. Cl. 219/400

(57) ABSTRACT

A baking apparatus for the baking of food mixtures or the like in an oven using steam and electric energy. The apparatus includes a steaming element and an electric heating element which are attached to a Timing unit and fan which distributes heat within the oven.

The apparatus is used for the baking of Bagels and other food mixtures. There are two positions for baking, one, for steaming of the bagels; the other for baking of other food mixtures.

The apparatus automatically processes the baking of Bagels without using any other apparatus.

The liquid for the steam is stored in a reservoir and distributed it into the heating element inorder to produce steam.

The baking apparatus also bakes by convection heating for the cooking of other food mixtures.

The invention may further be practiced by an apparatus comprising of a Timer built within the electrical system to produce variable times for the purpose of completing the baking requirements of the food mixture.

The invention may further be practiced by an apparatus comprising of two electric heating rods located on the exterior back wall of the oven cavity (1) one on the rear wall mounted onto the oven cavity and held in place with two stringers; the rods are energized with electricity for the baking of the food mixture within the cavity of the oven (2) The oven cavity has a fan which cirrculates the air through portholes on the back wall of the cavity .There is a Timer for the baking of the food mixture within the oven's cavity for the cooking of the food mixture after which the timer will activate its self for the completion of this baking cycle.

The invention may further be practiced by an apparatus comprising of a heating unit for the production of steam; this unit is attached to the timer which is preset for the unit to produce the right amount of steam for the cooking process of the food mixture. The steaming unit is found in the outer space of the right side of the oven cavity having a silinoid for the distribution of liquid into the heating unit for the production of steam

The invention may further be practiced by an apparatus comprising of a heating unit as a forementioned in the above paragraph for the production of heat within the oven's cavity.

This apparatus is connected to the timing unit; which is set for a cycle period to to the Timer inorder to controll the flow of the liquid into the heating unit FIG. 3#8 which is set for a cycle period to complete the cooking process of the food mixture within the cavity of the oven. The Timer is set to complete this cycle automatically which starts the next cycle for the baking of the food mixture.

The invention may further be practiced by switching on the start button to the Left for the convection oven system to work independently without the steaming unit for the cooking of different food mixtures having to be cooked without steam. The invention as a forementioned comprises of a heating element (rods) and a fan for the distribution of heat for the completion of the baking of the food mixtures. The rod ends FIG. 4 #10 located on the rear wall of the oven cavity having port holes to allow heat to be transported into the oven's cavity.

The fan#11 located behind the inner cavity of the oven is connected directly to the 115 voltage current supplied via the Timer FIG. #6 Referring to FIG 3.#2 having a description of the silinoid #2 connected to the Timer FIG. 6 located in the outer cavity on the rightside containing the reservoir #3. the silinoid #2 regulates the liquid flow into the heating element reservoir #3 which developes the steaming within the unit #8 FIGS. 3, 5, 4, which has transported the liquid through tubular hose which enters the oven cavity from the sidewall of the outer cavity of the oven#11, FIG. 2

The actual cooking process occurs when the ON button (not shown) which is connected to the main current line 115 volts described in the above artwork aforementioned FIG. 2, at the center of the outer cavity oven wall is turned on; the process is automaticly controlled by the Timer 6 which when activated delievers electric current to the above artwork.

### BRIFE DESCRIPTION OF THE DRAWINGS

The above mentioned and other features of the invention will now be more apparent by reading the description of the Perferred Embodiment with reference to the drawings wherein:

FIG. #1 is the front sectioned view of the Bagel Oven with a coil tube FIG. 1 #9 attached to the ceiling of the oven's cavity for the distribution of steam.

FIG. 2 is an expanded perspective view of the Bagel Oven showing heating portholes FIG. 2 #11 for the distribution of hot air into the oven's cavity. The heating elements used to produce heat for the baking of the food mixture within the oven's cavity. FIG. 1 #10 is located on the backwall of the oven's cavity exterior.

FIG. 2#12 is the reservoir on the top outer portion of the oven extruding through the oven's outer shell of the oven cavity which supplies the liquid to the silinoid FIG. 3#2 which distributes liquid into the heating unit FIG. 3# 8 that produces steam for the required amount of liquid for the baking of the food mixture. Within this perspective the coil rod located on the ceiling of the oven interior cavity for the purpose of distributing steam into the oven's cavity inorder to steam the Bagel and other food mixtures.

FIG. 3 is the front view of the steaming unity located in the rightside cavity of the outer firewall of the oven's cavity showing the hose connections FIG. 3 #4;5 which is connected to the Silinoid FIG. 3#2 that is connected to the Timer FIG. 5 within the compartment of the rightside of the firewall's outer shell.

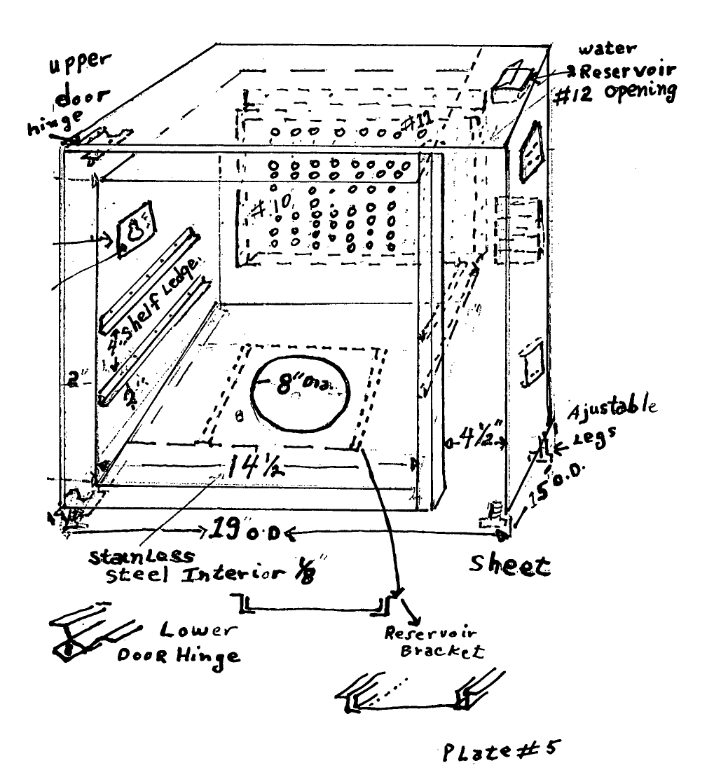

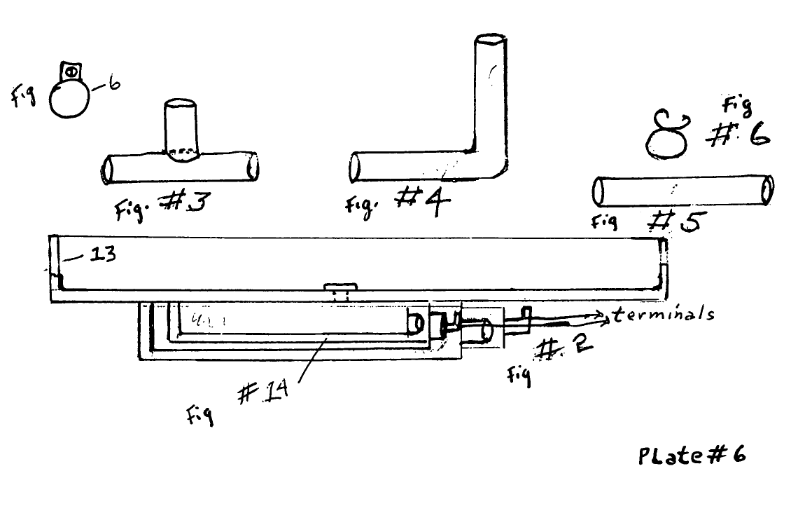

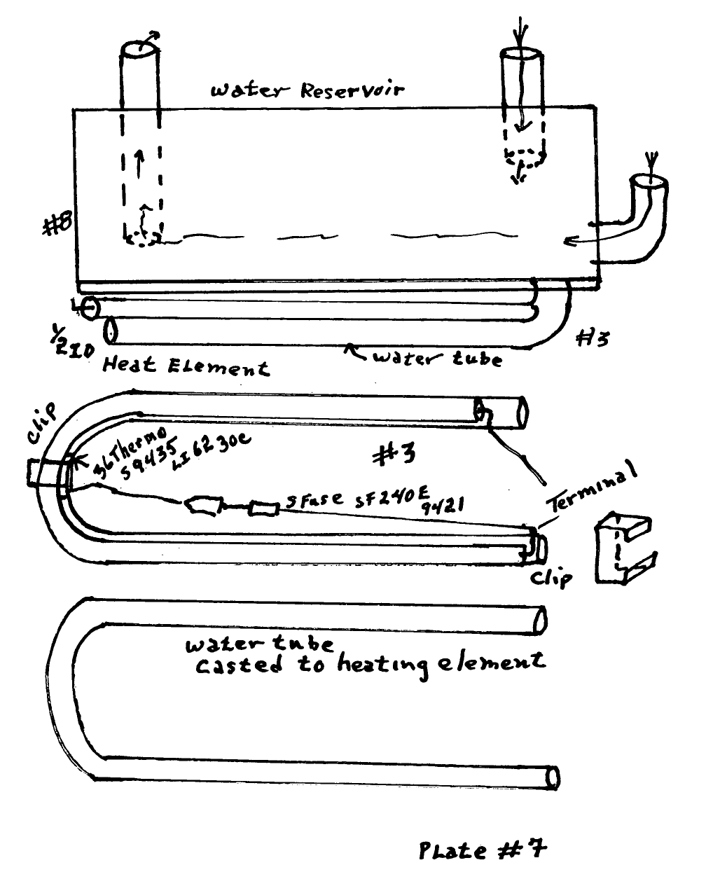

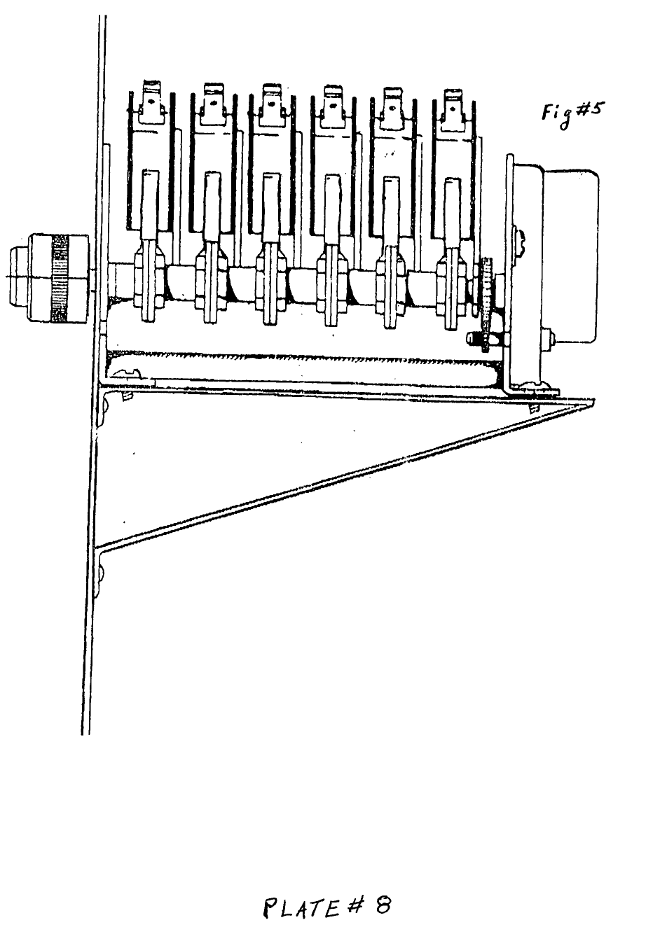

The metal tube connections are shown in FIG. 3 #4;5 and their placement within the apparent postions as aforementioned in FIG. 3. having the reservoir FIG. 3 #3 connected to the steam unit. The front view shows the position of the silinoid FIG. 3 #2 used for the distribution of liquid into the steaming unit as viewed in FIG. 3 The silnoid dispences the liquid into the reservoir FIG. 3 #3 at a set cycle through the timer inorder to controll the flow of liquid into the heating unit FIG. 3 #8.

### DISCRIPTION OF THE PREFERRED EMBODIMENT

FIG. 4 is the front view of the heating unit FIG. 4 #10 located on the rear wall of the oven's interior wall extending into the outer cavity of the oven; the heating rod FIG. 4# 10 is conncected to the Timer FIG. 6 which energizes the rod with electricity FIG. 1 #10 for the purpose of baking the food mixture within the oven's cavity; the FIG. 4#11 is the fan which is conncected the Timer FIG. 6, allowing for the required amount of heat energy through convection heating for the baking of the food mixture within the oven's cavity.

### DESCRIPTION OF THE PERFERRED EMBODIMENT

Referring more particularly to the drawings wherein like characters of reference designates like parts throughout the several views ,there is shown FIG. 1 an oven including an oven cavity FIG. 1; 10,9 having there in through the door (not shown with window). The oven cavity is supplied with electricity to produce steam FIG. 5#8; using a liquid transported via a tubual hose having portholes FIG. 3#4;5 via the reservoir FIG. 3 #1 having a silinoid #2 to supply a sufficent amount of liquid at intervals settings within a the Timer FIG. 6 these units are supplied with voltage of 115 volts from a line connected to the fuse box within the building; these are suitably wired to a cord which plugs into a socket and is grounded to the oven's outer cavity and the plug for the direct current voltage.

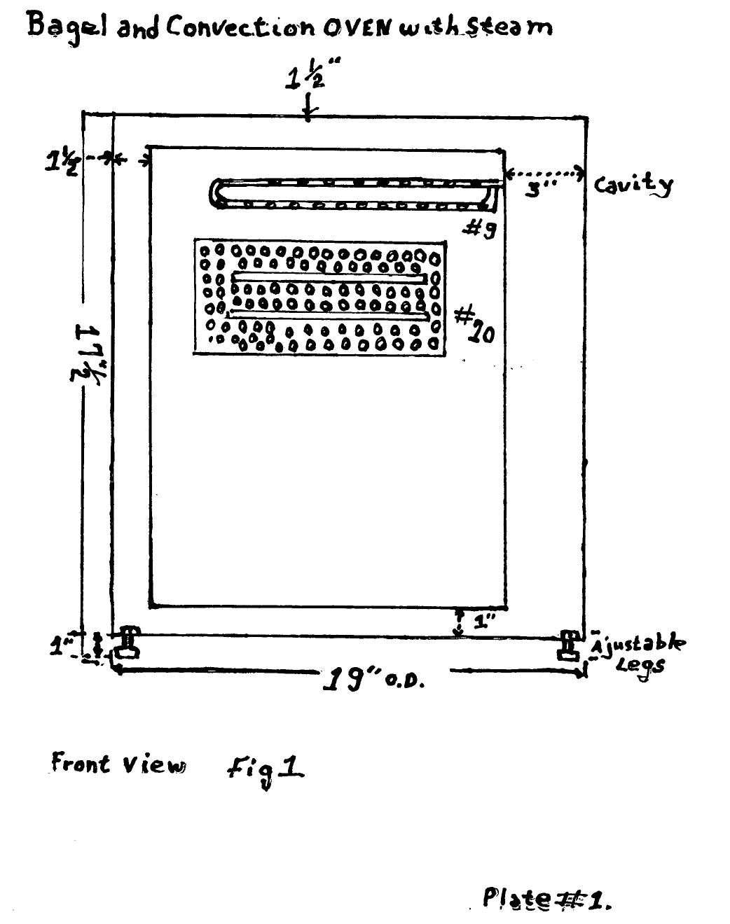

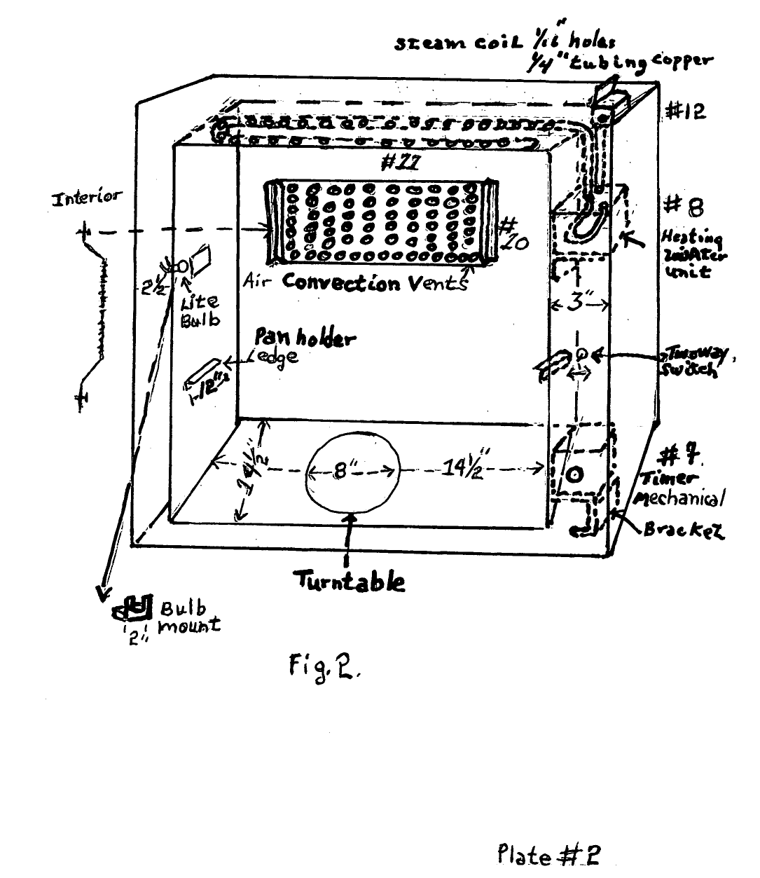

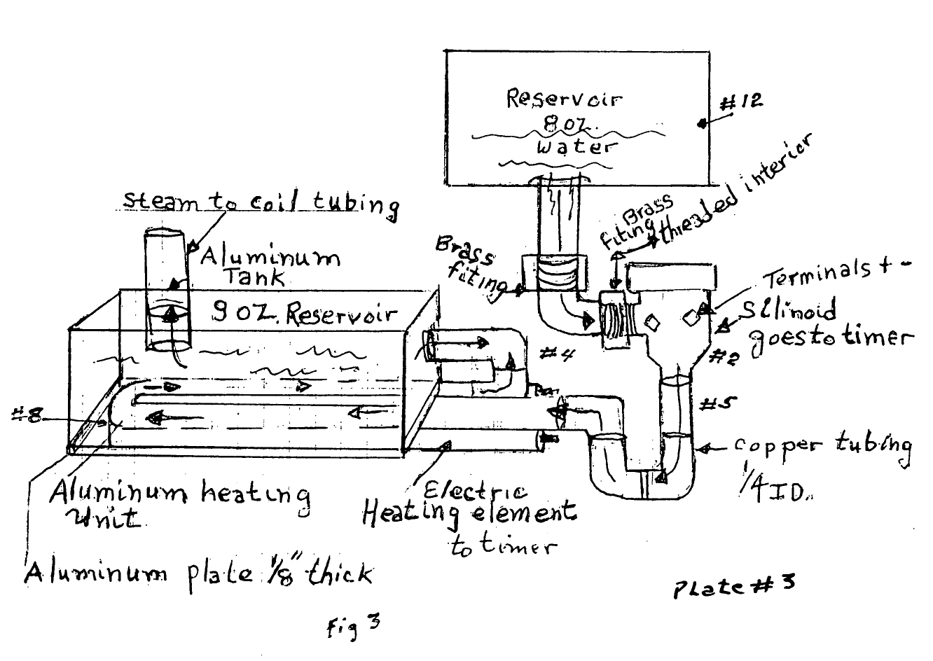

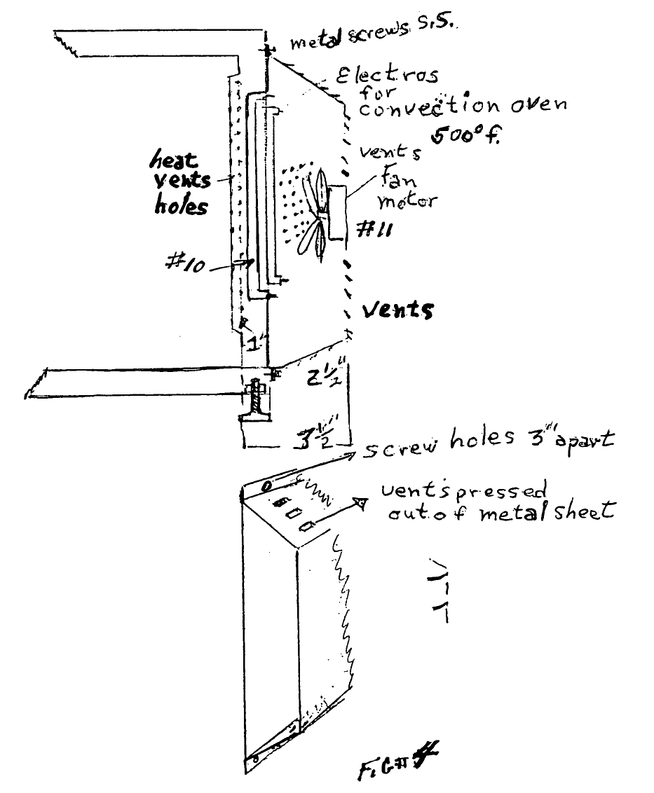

As is known in the art work, the oven further comprises a left side wall; a rightside wall, the opposing side wall; a floor, and a back wall. In the cavity is a turntable FIG. 2# 13 ,for the food mixture to rest on inorder to deliver heat evenly to the food mixture.

In addition, FIG. 1 shows the oven cavity reservoir #12 resting in the top portion of the outer shell having tubular hoses and connectors FIG. #4,5, hoses, the reservoir sets over the silinoid unit (2) within the outer cavity firewall of the outer shell of the oven having tubes connected to the silinoid FIG. 3#2 which dispenses liquid into a heating unit FIG. 3#8 which circulates liquid into a reservoir FIG. 3 #3 found in the outer cavity of the oven; which collectes liquid for the steaming process to be completed within the cavity of the oven.

Referring now to FIG. 4,#10 there is shown a side view of the heating rods; the rod ends FIG. 4#10 located on the rear wall of the oven cavity having portholes to allow heat to be transport into the oven's cavity. The fan #11 located behind the inner cavity wall of the oven is connected directly to the 115 voltage current supplied via the Timer FIG. 6.

Reffering to FIG. 3#2 having a description of the silinoid #2, connected to the Timer FIG. 6. located in the outer cavity on the rightside containing the reservoir #3, the silinoid, #2 regulates the liquid flows into the heating element reservoir #3, which developes the steam within the unit #8 FIG. 3,5,4 which has transport the liquid through the tubular hoses which enters the oven cavity from the sidewall of the outer cavity of the oven #11 FIG. 2.

The actual cooking process occurs when the ON botton (NOT SHOWN) which is connected to the main current line 115 volts described in the above artwork aforementioned FIG. 2, at the current of the outer cavity oven wall is turned on; the process is automatically controlled by the Timer #6 which when activated delivers electric current to the above artwork.

### DESCRIPTION OF PERFERED EMBODIMENT

The material used for all the attachments within the cavity of the oven should be material transparent to electric heat to the tempetures of 400 F. to 550 degrees F. in some cases glass may be used with some attachments; however, each part should be evaluated on the individual basis for trhe proper material choice, and designed for the proper interaction with the electric current energy to which it would be exposed to, not excluding the fact that, the oven and its attachments can be designed in different styles and materials and maybe modified and alter without departing from the spirit and scope of the invention. accordingly, it is intended that the invention only be limited by the following claims.

### BACKGROUND OF INVENTION

This invention relates to the baking of various food cooked by steam and by and heating by electric energy through convection method using hot air and has particular reference to appliances for baking flour products such as Bagels and pretzels with a oven using steam as part of its operation.

It is generally understood that heat and steam maybe applied to food or food mixture forms. These foods may be steamed heated and electrically heated by radiation or by convection or well known conventional stoves. The stoves may be fueled by electric energy, by the burning of liquid or gaseous fuel or by combustion of solid fuel. The baking of foods needing water or steam as part of the general cooking process which incorporates the baking of Bagel using steam or boiling of water is part of this apparatus.

The heating from flames is usually concentrated in an area used for the baking of bagels or any other foods needing to be boilded or steamed by water is accomplished by separate proceedures using separate apparatuses alternetly.

The Bagel oven has been deigned in such a manner that it bakes the food product in a single process allowing for the quicker and more effecient baking of other foods needing steam as part of the cooking media. The Bagel oven combines oven features found in ovens using electric energy or other fuels for the baking of food mixtures without the need of other apparartuses.

The Bagel oven does the following steps: (1) helps raise the dough (2) steams the Bagels and other food mixtures (3) bakes the food mixture (4) Bakes the Bagels. (5) bakes the Bagels procedure automatically without the need to use severseveral step or apparatuses to complete the baking process. It decrease the steps within the procedure of baking Bagels without the handling of the food mixture outside the oven. Each step is done within the oven itself . The oven apparatus completes the baking of the food mixture or other food products within itself.

The timing cycle when completed for the baking of the food mixture will then enter the next stage of the cooking process which is set by the Timer. After this cycle is complete the next cycle is set in motion by the Timing unit for the cooking process of the food mixture. The sequence of the cooking process is completd by the Timer which is preset to operate five functions at different intervals of time.

The invention may also be practiced by the comprising of two electric charged rods within the convection oven as a forementioned which is located on the exterior wall of the oven's cavity . These rods along with a fan distribute the heated air for the cooking of the food mixture.

These rods and fan are preset to operate by a Timer; which then completes the cooking process of the food mixtures. The heating rods are parallel to the floor of the oven and are horizontal to each other. The heat rods when energized together are used for the baking of the food mixture in two separate cooking procedures (1) for the baking of Bagels and other food mixtures needing steam to cook them (2) for the uses of the convection oven to cook any other food mixtures as generally cooked in an oven inorder to complete the cooking requirements.

### SUMMARY OF INVENTION

In accordance with the present invention and apparatus designed and adopted for the baking of Bagels is provided by using a steam apparatus for the purpose of

### SUMMARY OF INVENTION walls; having portholes in said wall for the distribution of hot air for the cooking process of the food mixture ; the convection heating system heats the oven cavity to 500 F. as required for the cooking of some food mixtures

The invention herein claims the invention reduces the process of making bagels and completes the process by first heating the oven to a temperature that is needed for the food mixture to rise within the ven's cavity. This is done on a timing cycle allowing for the cooking process to continue after which the Timer activates the steaming unit which is located between the outer shell and the firewall of the rightside of the oven's cavity and extends into the open space under the oven's cavity ceiling interior.

Steam which is produced through a heating element within the outer space as aforementioned enters the oven's cavity via a tubular coil which is extended through the rightside firewall into the oven's cavity for the distribution of steam for the cooking process . The food items are placed upon a tray having holes for the steam to circulate around the food mixture thus incompassing the the food mixture with steam to complete the cooking process.

The invention also claims that the oven can be used for general cooking; using a convection heating program for the cooking of food mixtures within the oven's cavity by turning to switch to the leftside allowing the convection portion of the oven to operate independently without steam for the cooking of other food mixtures within the oven cavity.

What is claimed is:

1. a utensil for holding food, said utensil being disposed within said oven cavity; a steam heating unit; connected to the timer in the outer shell of the oven cavity shell; for the cooking process; comprising of electric heating unit to produce steam which is developed through liquid that passes through tubular hoses into the heating elements via reservoir located in the outer cavity of the oven's firewall and outer shell.

2. The steaming unit produces steam which is transported through pipes which extend through the firewall into the cavity of the oven transporting the steam from the outer reservoir into the tubular coil hoses into the oven's cavity for the cooking of the food mixture.

3. The apparatus as recited in claim #1 further comprising of a heating element connected to a fan connected to the interior backwall on it's exterior to deliever hot air into the oven's cavity through portholes on the interior back wall, for the baking of the food mixture, which is attached to the timer with a cam driven apparatus delievering electricity to the heating unit for a peroid of time;

4. An apparatus comprising;
an oven having a cavity comprising first and second walls: a turntable within said cavity for the holding food.
a reservoir for transporting water to the steaming element within the outer cavity of the oven's cavity outer shell having a silinoid to regulate the flow of water into the reservoir.
a tubular hose coil connected to the steaming element for the transporting of the liquid from the reservoir into the heating element to produce steam into the said container;

5. The apparatus as recited in claim #1 wherein said rod comprises of a timing device with cam for the relaying of electricity for the heating of the rods for the cooking of the food mixture;

6. The apparatus as recited in claim #1 wherein said turntable located on the floor of the oven's cavity driven by a belt connected to a pulley and gear connected to the fan motor for the turning of food for even cooking of the food

7. The apparatus as recited in claim 2 a a reservoir to distribute liquid into a tubular hose transporting the liquid into the heating element which produces steam. In claim 2 the reservoir is connected to the tubular hose which is connected to the steaming unit which has a connection which the liquid enters into the steaming unit for the production of steam for the cooking of the food mixture.

8. The apparatus as recited in claim 2 as a steaming unit for proper requirement for the cooking process of the food mixture; this done with the use of liquid within the steaming unit.

9. The apparatus as recited in claim 3. as two heating rods used for heating the food mixture within the oven's cavity to the proper temperature are connected to the electric wiring harness which is connected to the timer's cam for a perset time for the proper cooking time requirement in the cooking process of the food mixture within the cavity of the oven. The fan connected to the electric harness produces air which is heated by the electric rods for the completion of the cooking process. The rods are connected to the Cam's Timer which are energized by 115 volts which is received through the transmission of electric current into the Timer which is plugged into an electric socket as a means for operating of the Cam of said Timer is supported by electric current received through the electric outlet as a means for the operating the complete cycle for the cooking of the food mixture. The timing cycle produced through the Timer which is connected to the Cam Timer is preset for the cooking requirements of the food mixtures.

10. AN APPARATUS COMPRISING:
a oven cavity:
a reservoir to transport liquid through the tubular hoses
a heating element to raise the food mixture to the proper food requirement for the ccoking of the food mixture.
a steaming element to produce steam for the proper cooking of the food mixture. The steaming unit is used to create heat without liquid for the raising of the food mixture within the oven cavity.
a silinoid adapter for the distributing of the liquid into the steaming unit to produce steam within the cavity of the oven.
a drain located within the cavity of the oven for the purpose of draining off excess liquid within the cavity of the oven resting on the floor of the oven cavity and extending into the outer reservoir under the outer shell of the oven's cavity's exterior.
a steaming unit for the preparation of the cooking process of the food mixture within the oven cavity.
a electric heating system using the two rods found on the back wall of the oven cavity resting on hangers and distributing hot air through the opposing walls they are used to complete the cooking process of the food mixture; the convection heats the oven cavity to 500 F. as required for the cooking of the food mixture.
The apparatus as recited in said claim 1 having an inner cavity made of stainless steel an a outer shell made of metal to form an encasement around the inner oven cavity.

3. The apparatus as recited in claim #1 further comprising of a heating element connected to a fan connected to the interior backwall on it's exterior wall to deliever hot air into the oven's cavity through portholes on the interior back wall, for the distribution of hot air for the baking of the food mixtures, which is attached to the Timer with a Cam driven apparatus delievering electricity to the heating unit for a period of time;

4. An Apparatus Comprising;
an oven having a cavity comprising first and second walls: a turntable within said cavity for the holding of the food mixture and for evenly cooking of the food mixtures.
an a reservoir for the transporting of liquid to the steaming unit within the outer cavity of the oven's cavity outer shell having a silinoid to regulate the flow of water into the reservoir.
a tubular hose coil connected to the steaming element for the transporting of liquid from the reservoir into the heating element to produce steam into the said container;

5. The apparatus as recited in claim #1 wherein said rods comprises of a timing device with Cam for the relaying of electricity for the energizing of the heating rods for the cooking of the food mixtures;

6. The apparatus as recited in calim #1 wherein said tuntable is located on the floord of the oven's cavity driven by a belt connected to a pully and gear connected to the fan motor for the turning of the table for even cooking of food.
